(19) United States
(12) Patent Application Publication
(10) Pub. No.: US 2009/0128355 A1
(43) Pub. Date: May 21, 2009

(54) DEVICE FOR VISIBLY MARKING A WATER OUTPUT MEANS AND METHOD OF USE

(76) Inventor: Mark URBIN, Douglasville, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 11/943,742

(22) Filed: Nov. 21, 2007

(51) Int. Cl. G08B 5/00

(52) U.S. Cl. 340/815.4

(57) ABSTRACT

In one aspect, the present invention relates to a device for visibly marking a fire hydrant. In one embodiment, the device for visibly marking a fire hydrant has a ring-shaped body portion defining a bore between a first end surface and an opposite, second end surface, a light emitting means disposed on the body portion, and at least one photovoltaic device disposed on the first end surface and positioned to be exposed to the external environment, for powering the light emitting means.

### FIELD OF THE INVENTION

The present invention is generally related to a device for visibly marking a water output means and a method of use.

### BACKGROUND OF THE INVENTION

Water output means such as fire hydrants are used in most urban, suburban, and rural areas as active fire protection measures, to enable firefighters to tap into the municipal water supply to assist in extinguishing a fire. Upon reaching the scene of a fire, a firefighter must quickly locate the nearest operational water output means. Inclement weather, darkness, or other conditions of limited visibility can make this task especially difficult. Rain or fog can obscure the view of a firefighter, and ice or snow may accumulate on the external portions of the water output means, making it more difficult to be identified. Even after a water output means has been located, there may be no immediate way of verifying whether it is operational.

Therefore, a heretofore unaddressed need still exists in the art to address the aforementioned deficiencies and inadequacies.

### SUMMARY OF THE INVENTION

The present invention, in one aspect, relates to a device for visibly marking a fire hydrant. In one embodiment, the device has a ring-shaped body portion defining a bore between a first end surface and an opposite, second end surface, a light emitting means disposed on the body portion, and, at least one photovoltaic device disposed on the first end surface and positioned to be exposed to the external environment, for powering the light emitting means.

The body portion has an inside ring surface and an opposite, outside ring surface. When in operation, the body portion receives a top cap or an outlet cap of the fire hydrant through the bore of the body portion such that the at least one photovoltaic device disposed on the first end surface is exposed to the external environment.

The light emitting means has at least one first color light element for emitting light of a first color and at least one second color light element for emitting light of a second color that is different from the first color, where the first color corresponds to an operational fire hydrant and the second color corresponds to a non-operational fire hydrant.

Furthermore, the device has a user-accessible switching device electrically coupled to the at least one first color light element and the at least one second color light element, respectively, where the user-accessible switching device is adapted for selectively activating one of the at least one first color light element or the at least one second color light element at a time.

Moreover, the device has least one heating element for melting precipitation on external surfaces of the body portion, at least one light cover for covering the light emitting means, where the light cover is at least partially optically transparent to allow light from the light emitting means to pass through to the external environment, and, at least one access hole defined through the body portion from the first end surface to the second end surface and between the inside ring surface and the opposite, outside ring surface, for receiving attachment means to attach the body portion to the fire hydrant.

In another aspect, the present invention relates to a method for visibly marking a water output means. In one embodiment, the method has the steps of associating a marking device with the water output means, where the marking device has a light emitting means that receives energy from the external environment for illuminating the water output means to the external environment, and, turning on the marking device to visibly mark the water output means.

In one embodiment, the water output means is a fire hydrant and the light emitting means has at least one first color light element for emitting light of a first color and at least one second color light element for emitting light of a second color that is different from the first color.

The method further has the step of activating the at least one first color light element to emit light of the first color if the fire hydrant is operational, or the at least one second color light element to emit light of the second color if the fire hydrant is not operational.

In yet another aspect, the present invention relates to a device for visibly marking a water output means. In one embodiment, the device has a body portion for attachment to the water output means, a light emitting means disposed on the body portion for illuminating the water output means to the external environment, and, at least one power source for powering the light emitting means.

In one embodiment, the water output means is a fire hydrant, where the body portion is adapted for attaching to an external portion of the fire hydrant, and where the external portion is a top cap or an outlet cap.

The light emitting means has at least one first color light element for emitting light of a first color and at least one second color light element for emitting light of a second color that is different from the first color. In operation, the first color corresponds to an operational fire hydrant and the second color corresponds to a non-operational fire hydrant. The device further has a switching device adapted for selectively activating one of the at least one first color light element or the at least one second color light element.

The power source has a photovoltaic device. The device for visibly marking a water output means further has at least one heating element adapted for melting weather precipitation on external surfaces of the body portion.

The device also has at least one light cover for covering the light emitting means, where the light cover is at least partially optically transparent to allow light from the light emitting means to pass through to the external environment. The device further has at least one access hole defined through the body portion, for receiving attachment means to attach the body portion to the water output means.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 shows schematically a partial view of a device for visibly marking a water output means according to one embodiment of the present invention, attached to a first type of water output means.

FIG. 2 shows schematically a partial view of a device for visibly marking a water output means, according to the embodiment shown in FIG. 1, attached to a second type of water output means.

FIG. 3A shows schematically a partial view of a device for visibly marking a water output means according to another embodiment of the present invention.

FIG. 3B shows schematically a circuit used in the device for visibly marking a water output means according to the embodiment shown in FIG. 3A.

FIG. 4A shows schematically a partial view, taken from a top view, of a device for visibly marking a water output means according to another embodiment of the present invention.

FIG. 4B shows schematically a cross-sectional view of the device for visibly marking a water output means according to the embodiment shown in FIG. 4A.

FIG. 5 shows schematically a cross-sectional partial view of a device for visibly marking a water output means according to another embodiment of the present invention.

FIG. 6 shows schematically a cross-sectional partial view of a device for visibly marking a water output means according to another embodiment of the present invention.

FIG. 7 shows schematically a cross-sectional partial view of a device for visibly marking a water output means according to another embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

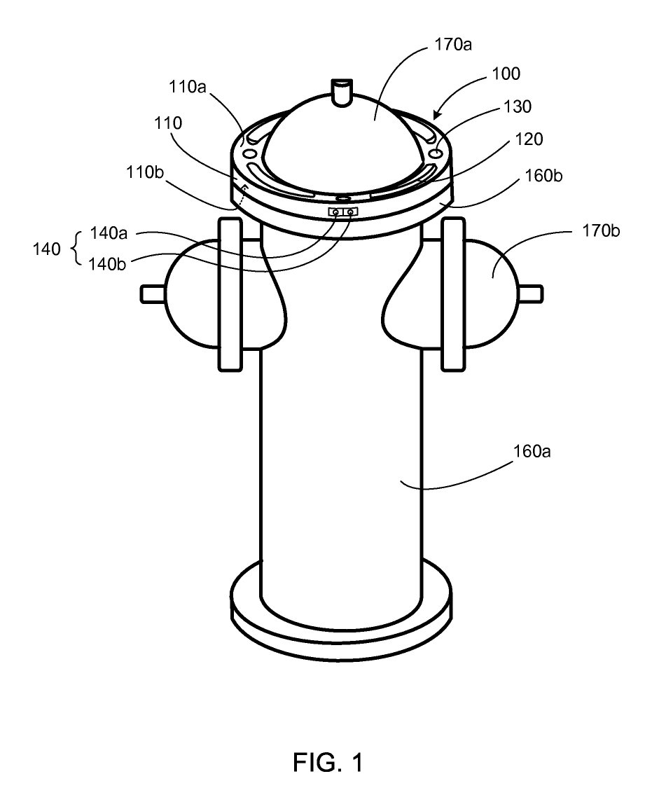

The description will be made as to the embodiments of the present invention in conjunction with the accompanying drawings in FIGS. 1-7. In accordance with the purposes of this invention, as embodied and broadly described herein, this invention, in one aspect, relates to a device for visibly marking a water output means.

Referring to FIG. 1, a partial view of a device 100 for visibly marking a water output means 160 is schematically shown. In this exemplary embodiment, the device 100 has a ring-shaped body portion 110 defining a bore between a first end surface 110a and an opposite, second end surface 110b, a light emitting means 140 disposed on the body portion 110, and at least one photovoltaic device 120 disposed on the first end surface 110a and positioned to be exposed to the external environment, for powering the light emitting means 140. The device 100 also has at least one access hole 130 defined through the body portion 110 from the first end surface 110a to the second end surface 110b, for receiving attachment or engagement means to attach or engage the body portion 110 to a water output means 160.

As shown in FIG. 1, the water output means 160 is a type of fire hydrant with a top cap 170a, an outlet cap 170b, a main shaft portion 160a, and a ledge portion 160b, where the top cap 170a is bolted at its base to the ledge portion 160b by threaded bolts. Unlike the top cap 170a, the outlet cap 170b of this type of fire hydrant is removed when the fire hydrant being operated to provide an output of water. The device 100 is attached over the top cap 170a at its base and directly on top of the ledge portion 160b. This can be accomplished by drilling threaded tap holes into the top of the existing bolts which anchor the top cap 170a to the ledge portion 160b, then placing additional threaded bolts (not shown) through the at least one access hole 130 defined through the body portion 110, into the tap holes and threads in the existing bolts.

The light emitting means 140 includes at least one first color light element 140a for emitting light of a first color and at least one second color light element 140b for emitting light of a second color that is different from the first color, where the first color corresponds to an operational fire hydrant and the second color corresponds to a non-operational fire hydrant. For example, the first color can be blue, and the second color can be red. Other colors can also be chosen The light emitting means 140, first color light element 140a, and second color light element 140b can take the form of one or more light emitting diodes (LEDs), or other types of light sources that provide visible light without requiring large amounts of power.

The at least one photovoltaic device 120 can take the form of one or more optical-electronic devices, such as photocells, photodiodes, or phototransistors that receive visible or ultraviolet light and produce electrical current, which can then be directly applied to power other electrically coupled elements such as the light emitting means 140, or stored in charge storing devices such as a capacitors. The light emitting means 140 may receive power exclusively from the at least one photovoltaic device 120 or alternatively may use a combination of power from the at least one photovoltaic device 120 and another supplementary source of power such as a battery.

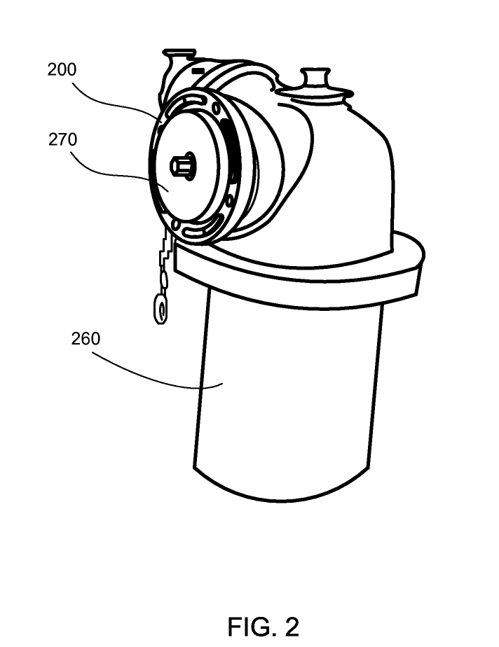

Referring to FIG. 2, a partial view of a device 200 for visibly marking a water output means 260 is schematically shown. In this exemplary embodiment, the water output means 260 is another type of fire hydrant with a top cap 270. As shown, the device 200, which has substantially same structure and functions as the device 100 does as set forth above, is attached over the top cap 270 at its base.

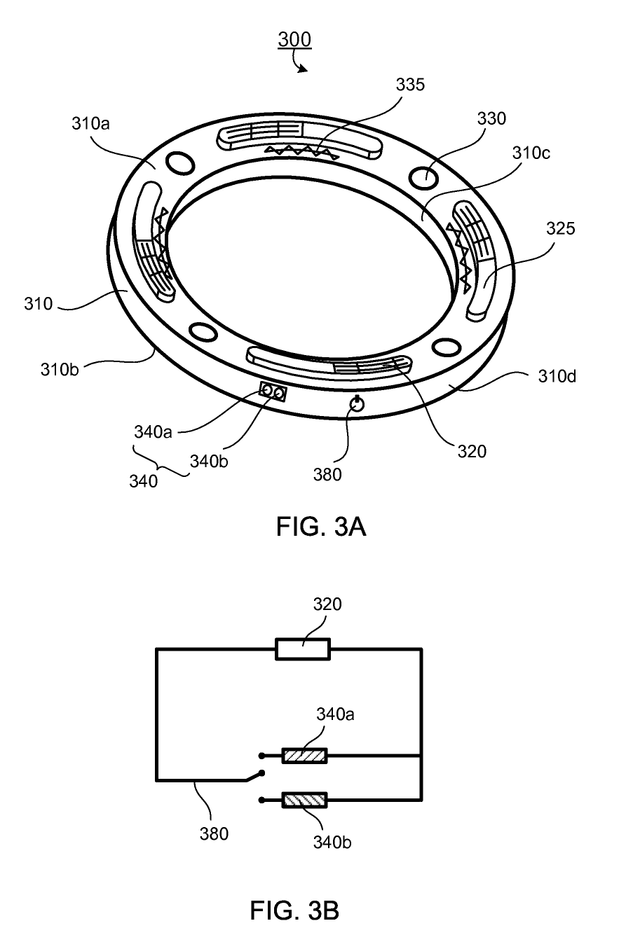

Referring to FIG. 3A, a partial view of a device 300 for visibly marking a water output means is schematically shown. In this exemplary embodiment, the device 300 has a ring-shaped body portion 310 defining a bore between a first end surface 310a and an opposite, second end surface 310b, a light emitting means 340 disposed on the body portion 310, and at least one photovoltaic device 320 disposed on the first end surface 310a and positioned to be exposed to the external environment, for powering the light emitting means 340. The body portion 310 has an inside ring surface 310c and an opposite, outside ring surface 310d. When in operation, the body portion 310 receives a top cap or an outlet cap of a water output means through the bore of the body portion 310 such that the at least one photovoltaic device 320 disposed on the first end surface 310a is exposed to the external environment.

The light emitting means 340 includes at least one first color light element 340a for emitting light of a first color and at least one second color light element 340b for emitting light of a second color that is different from the first color, where the first color corresponds to an operational water output means and the second color corresponds to a non-operational water output means. As shown, the light emitting means 340 is disposed on the outside ring surface 310d of the body portion 310.

A user-accessible switching device 380, such as a three-way, simple changeover switch, is electrically coupled to the at least one first color light element 340a and the at least one second color light element 340b, respectively, and adapted for selectively activating one of the at least one first color light element 340a or the at least one second color light element 340b at a time.

As shown in FIG. 3, the portion of the user-accessible switching device 380 on the outside ring surface 310d of the body portion 310 is a key hole, for receiving a key such as a circular key, for use by parties having authorized access to the operation of the device 300.

The device 300 also has at least one heating element 335 for melting precipitation on external surfaces of the body portion 310. The heating element 335 can take the form of one or more resistors electrically coupled with the photovoltaic means 320, for melting snow or ice on the external surfaces of the device 300 such that the photovoltaic device 320 and light emitting means 340 are not blocked from receiving light and emitting light, respectively. At least one light cover 325 covers the light emitting means 340. The light cover 325 is at least partially optically transparent to allow light from the light emitting means 340 to pass through to the external environment, and may be formed with plastic, glass, or other materials having optical transparency. The device 300 also has at least one access hole 330 defined through the body portion 310 from the first end surface 310a to the second end surface 310b and between the inside ring surface 310c, and the opposite, outside ring surface 310d, for receiving attachment means to attach the body portion 310 to a water output means.

Referring to FIG. 3B, a circuit used in the device 300 for visibly marking a water output means is schematically shown. The user-accessible switching device 380 is electrically coupled to the at least one first color light element 340a and the at least one second color light element 340b, respectively, and is adapted for selectively activating one of the at least one first color light element 340a or the at least one second color light element 340b at a time. The at least one photovoltaic device 320 for powering the light emitting means 340a, 340b is also electrically coupled in the circuit to the switching device 380 and the light emitting means 340a, 340b, respectively.

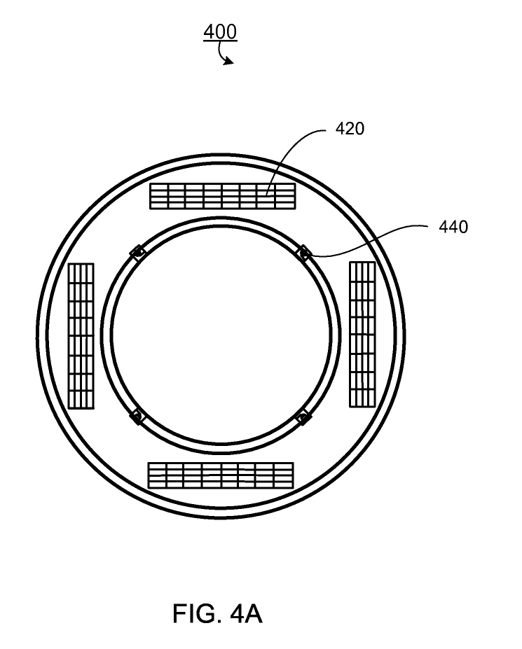

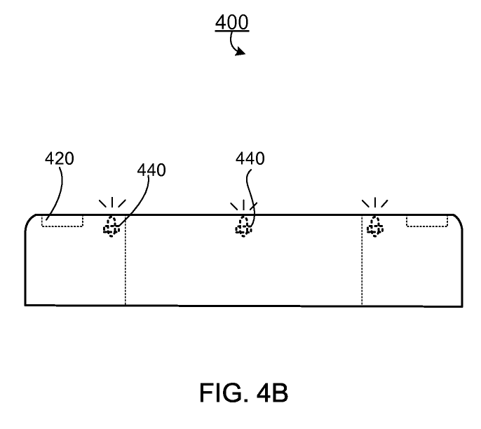

Referring to FIG. 4A, a partial view taken from a top view of a device 400 for visibly marking a water output means is schematically shown. In this exemplary embodiment, the device 400 has a photovoltaic device 420 and a light emitting means 440. FIG. 4B shows schematically a cross-sectional view of the device 400 of FIG. 4A.

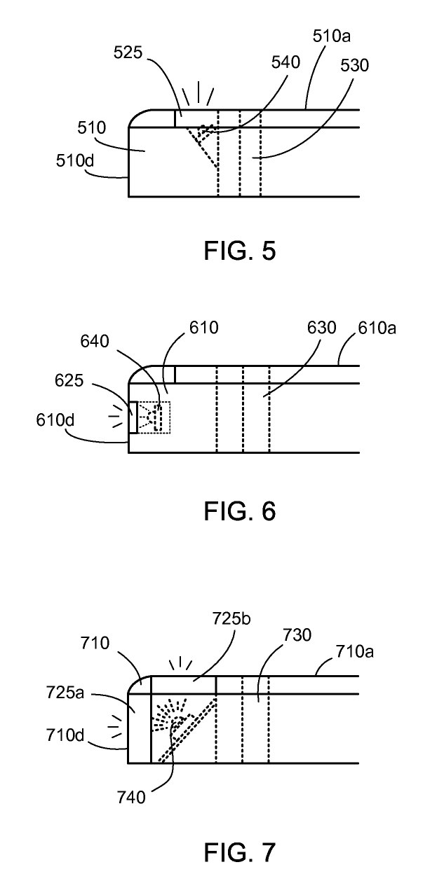

Referring to FIG. 5, a cross-sectional partial view of a device 500 for visibly marking a water output means is schematically shown. In the exemplary embodiment shown in FIG. 5, the device 500 has at least one access hole 530 and a light cover 525 covering the light emitting means 540, where the light cover 525 is at least partially optically transparent to allow light from the light emitting means 540 to pass through to the external environment. The light emitting means 540 is recessed in body portion 510 and angled to emit light to the external environment through the light cover 525 in a direction facing both the first end surface 510a and outside ring surface 510d.

In the exemplary embodiment shown in FIG. 6, the light emitting means 640 is recessed in body portion 610 and disposed to emit light to the external environment through the light cover 625 in a direction facing the outside ring surface 610d.

In the exemplary embodiment shown in FIG. 7, the light emitting means 740 is recessed in body portion 710 and angled to emit light to the external environment through light covers 725a and 725b in directions facing both the first end surface 710a and outside ring surface 710d.

In another aspect, the present invention relates to a method for visibly marking a water output means. In one embodiment, described in connection with FIG. 1, the method has the steps of associating a marking device 100 with the water output means 160, where the marking device 100 has a light emitting means 140 that receives energy from the external environment for illuminating the water output means 160 to the external environment, and, turning on the marking device 100 to visibly mark the water output means 160.

In one embodiment, the light emitting means 140 has at least one first color light element 140a for emitting light of a first color and at least one second color light element 140b for emitting light of a second color that is different from the first color, and the water output means 160 is a fire hydrant.

The method further has the step of activating the at least one first color light element 140a to emit light of the first color if the fire hydrant 160 is operational, or the at least one second color light element 140b to emit light of the second color if the fire hydrant 160 is not operational.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A device for visibly marking a fire hydrant, comprising:
a) a ring-shaped body portion defining a bore between a first end surface and an opposite, second end surface;
b) a light emitting means disposed on the body portion; and
c) at least one photovoltaic device disposed on the first end surface and positioned to be exposed to the external environment, for powering the light emitting means.

2. The device of claim 1, wherein the light emitting means comprises at least one first color light element for emitting light of a first color and at least one second color light element for emitting light of a second color that is different from the first color, wherein the first color corresponds to an operational fire hydrant and the second color corresponds to a non-operational fire hydrant.

3. The device of claim 2, further comprising a user-accessible switching device electrically coupled to the at least one first color light element and the at least one second color light element, respectively, and adapted for selectively activating one of the at least one first color light element or the at least one second color light element at a time.

4. The device of claim 1, wherein the body portion further has an inside ring surface, and an opposite, outside ring surface, and wherein when in operation, the body portion receives a top cap or an outlet cap of the fire hydrant through the bore of the body portion such that the at least one photovoltaic device disposed on the first end surface is exposed to the external environment.

5. The device of claim 4, further comprising:
a) at least one heating element for melting precipitation on external surfaces of the body portion;
b) at least one light cover for covering the light emitting means, wherein the light cover is at least partially optically transparent to allow light from the light emitting means to pass through to the external environment; and
c) at least one access hole defined through the body portion from the first end surface to the second end surface and between the inside ring surface, and the opposite, outside ring surface, for receiving attachment means to attach the body portion to the fire hydrant.

6. A method for visibly marking a water output means, comprising the steps of:
a) associating a marking device with the water output means, wherein the marking device has a light emitting means that receives energy from the external environment for illuminating the water output means to the external environment; and
b) turning on the marking device to visibly mark the water output means.

7. The method of claim 6, wherein the light emitting means comprises at least one first color light element for emitting light of a first color and at least one second color light element for emitting light of a second color that is different from the first color.

8. The method of claim 7, wherein the water output means is a fire hydrant.

9. The method of claim 8, further comprising the step of activating the at least one first color light element to emit light of the first color if the fire hydrant is operational, or the at least one second color light element to emit light of the second color if the fire hydrant is not operational.

10. The method of claim 6, wherein the light emitting means is powered by a photovoltaic device.

11. A device for visibly marking a water output means, comprising:
a) a body portion for attachment to the water output means;
b) a light emitting means disposed on the body portion for illuminating the water output means to the external environment; and
c) at least one power source for powering the light emitting means.

12. The device of claim 11, wherein the water output means is a fire hydrant and the body portion is adapted for attaching to an external portion thereof.

13. The device of claim 12, wherein the external portion is a top cap or an outlet cap.

14. The device of claim 11, wherein the light emitting means comprises at least one first color light element for emitting light of a first color and at least one second color light element for emitting light of a second color that is different from the first color.

15. The device of claim 14, wherein the water output means is a fire hydrant, and wherein the first color corresponds to an operational fire hydrant and the second color corresponds to a non-operational fire hydrant.

16. The device of claim 15, further comprising a switching device adapted for selectively activating one of the at least one first color light element or the at least one second color light element.

17. The device of claim 11 wherein the power source comprises a photovoltaic device.

18. The device of claim 11, further comprising at least one heating element adapted for melting weather precipitation on external surfaces of the body portion.

19. The device of claim 11, further comprising at least one light cover for covering the light emitting means, wherein the light cover is at least partially optically transparent to allow light from the light emitting means to pass through to the external environment.

20. The device of claim 11, further comprising at least one access hole defined through the body portion, for receiving attachment means to attach the body portion to the water output means.
